(19) United States
(12) Patent Application Publication
(10) Pub. No.: US 2018/0049293 A1
(43) Pub. Date: Feb. 15, 2018

(54) PRESENCE REQUEST VIA LIGHT ADJUSTMENT

(71) Applicant: PHILIPS LIGHTING HOLDING B.V., EINDHOVEN (NL)

(72) Inventors: JAN MARTIJN KRANS, DEN BOSCH (NL); JONATHAN DAVID MASON, WAALRE (NL); FRANCISCUS JACOBUS VOSSEN, HELMOND (NL); JUDITH HENDRIKA MARIA DE VRIES, BUDEL-SCHOOT (NL)

(21) Appl. No.: 15/556,143

(22) PCT Filed: Mar. 2, 2016
(86) PCT No.: PCT/EP2016/054356

§ 371 Date: Sep. 6, 2017

(30) Foreign Application Priority Data
Mar. 6, 2015 (EP) 15158058.6

(51) Int. Cl. H05B 37/02; H04L 12/28; G08B 21/22

(52) U.S. Cl. CPC H05B 37/0227; H05B 37/0272; G08B 21/22; H04L 12/282

(57) ABSTRACT

A system (100) for determining the presence of a person is disclosed. The system (100) comprises a first user input device (102), located at a first space (112), arranged for generating a request signal based on a first user input. The system further comprises a plurality of lighting devices (108, 110), located at a second space (114), different from the first space (112), arranged for providing general illumination. The system further comprises a second device (104), located at the second space (114), arranged for generating a response signal, wherein the response signal is based on an indication of the presence of the person. The system further comprises a processor (106) arranged for receiving the request signal and the response signal, wherein the processor (106) is further arranged for changing a light setting of a first lighting device (108) of the plurality of lighting devices (108, 110) upon receiving the request signal, and for changing, when the response signal has not been received within a predetermined period of time, the light setting of a subsequent lighting device (110) of the plurality of lighting devices (108, 110).

### FIELD OF THE INVENTION

The invention relates to a system and method for controlling a plurality of lighting devices and a controller for use in the system. The invention further relates to a computer program product for performing the method.

### BACKGROUND OF THE INVENTION

Future and current home and professional environments will contain a large number of controllable lighting devices for creation of ambient, atmosphere, accent or task lighting. The emergence of the internet of things will provide humans the possibility to control these lighting devices from remote places, thereby creating new interaction paradigms which may extend beyond regular lighting control. An example is to use lighting as a social interaction means, allowing humans that are located distantly from each other to send messages or signals via their lighting devices. The Good Night Lamp (www.goodnigthtlamp.com) discloses a set of lamps connected via the internet allowing users in a first place to turn on a lamp in a second place by pushing a button on a lamp at the first place. This allows people to communicate with others in a playful way.

Document D1 relates to a light-based system for forming social connections. The system comprises: a first lighting controller, a first memory, a processor, a communication network, a second lighting controller and a second memory. The first lighting controller controls a plurality of individually controllable luminaires in a lighting network, located at a first location, and transmits a first signal indicative of a first location identifier and a second signal indicative of a first localized light setting associated with the first location identifier. The processor receives the second signal from the first lighting controller and receives from the first memory at least one second location identifier associated with a second localized light setting where a correlation exists between the second localized light setting and the first localized light setting. The communication network transmits a third signal indicative of a potential for a light-based connection, which may comprise a signal indicative of an increase in the brightness associated with the second localized light setting. The second lighting controller controls individually controllable luminaires at the second location. The second lighting controller receives the third signal from the communication network and may transmit, in response, a fourth signal indicative of an interest in establishing a light-based connection. The processor may subsequently receive the fourth signal and create an association between the first location identifier and the second location identifier in the second memory. The fourth signal may comprise a signal indicating an increase in a brightness associated with the first localized light setting. The fourth signal and the third signal may be temporally separated by at most a predetermined interval in order for the fourth signal to be considered responsive to the third signal and indicative of an interest in establishing a light-based connection. The system may further comprise a first user interface for communicating first light settings to the first lighting controller and a second user interface for communicating second light settings to the second lighting controller.

### SUMMARY OF THE INVENTION

It is an object of the present invention to provide a system, a controller, a method and a computer program product which enable requesting the presence of a person.

According to a first aspect of the present invention the object is achieved by a system for determining the presence of a person. The system comprises:

a first user input device, located at a first space, arranged for generating a request signal based on a first user input,

a plurality of lighting devices, located at a second space different from the first space, arranged for providing general illumination,

a second device, located at the second space, arranged for generating a response signal, wherein the response signal is based on an indication of the presence of the person, and

a processor arranged for receiving the request signal and the response signal, wherein the processor is further arranged for:
changing a light setting of a first lighting device of the plurality of lighting devices upon receiving the request signal, and
changing, when the response signal has not been received within a predetermined period of time, the light setting of a subsequent lighting device of the plurality of lighting devices.

An advantage of this system is that it may use permanently installed lighting devices that provide general illumination to request the presence of the person, thereby removing the need for a dedicated communication device. By changing the original light setting of the plurality of lighting devices, the system indicates to the person at the second location, henceforth referred to as the second person, that a person at the first location, henceforth referred to as the first person, requests his or her presence. The original light setting (e.g. an ‘off’ setting, a default light setting or a user defined light setting) is overruled by a request light setting by the processor. By changing the light setting of the plurality of lighting devices subsequently the system is able to address all subspaces of the second space, each subspace comprising at least one controllable lighting device, thereby continuously expanding the reach of the request signal. When the response signal (i.e. a signal representative of the presence of the second person) is received, the system may determine that the second person is present in the (subspace of the) second space, whereupon it may be no longer required to change the light setting of a subsequent lighting device. The system provides the advantage that it enables requesting the presence of the second person regardless of the location of the second person in the second space. By subsequently changing light settings of the lighting devices, for example by subsequently switching them on, not all lighting devices need to be controlled at the same time, which is advantageous because it may reduce the energy consumption of the system and increase the life time of the lighting devices.

In an embodiment of the system, the processor is further arranged for generating a response status based on the response signal or based on that no response signal has been received within the predetermined period of time. The response status may for example comprise information about the time between the changing of the light setting of a specific lighting device and the reception of the response signal, about the number of lighting devices of which the light setting has been changed and/or at which location a responding person is in vicinity based on the relation between the moment of changing the light setting of a lighting device and the moment of receiving the response signal.

In a further embodiment of the system, the processor is further arranged for communicating the response status to the first user input device. The advantage of communicating the response signal to the first user input device is that it allows the system to inform the first person operating the first user input device of the response status. By communicating the response status to the first device, the system may further change a setting or a control parameter of the first user input device (e.g. emit sound, turn on a light source, vibrate, etc.). In a further embodiment, the processor may be further arranged for changing the light setting of a further lighting device, located in the first space, based on the response status. This allows the system to inform the first person in the first space that the response signal has been received, or that no response signal has been received.

In an embodiment of the system, the second device is arranged for identifying the responding person, and the response signal comprises the identification of the person, thereby informing the processor of the identity of the responding person. The advantage of identifying the person, in an embodiment wherein the presence request is targeted at a specific second person, is that the system is able to exclude persons from responding if they were not targeted by the request. It may further allow the system to receive the response signal from the intended second person only. It may be further advantageous, in an embodiment wherein the request signal was not targeted at a specific second person, to identify the second person that is providing the response. The system may further communicate the response signal to the first user input device, thereby informing the first person about the identity of the responding person.

In an embodiment of the system, the processor is further arranged for determining at which lighting device the person is in vicinity based on the relation between the moment of changing the light setting of a lighting device and the moment of receiving the response signal. This embodiment is advantageous because if the location of the second device and/or the location of the lighting device are known by the processor, the processor may infer the location of the person based on the relation between the moment of changing the light setting of a lighting device and the moment of receiving the response signal. The location of the second person and/or the relation between the moment of changing the light setting of a lighting device and the moment of receiving the response signal, may be communicated to the first user input device, thereby possibly informing the first person about the location of the second person.

In an embodiment of the system, the processor is further arranged for changing the light setting of a preceding lighting device to an original light setting upon changing the light setting of the subsequent lighting device, the original light setting being the light setting of the lighting device before being changed by the processor. The original status may be, for example, completely turned off, or it may be a light setting according to a user preference. This embodiment is advantageous in situations wherein it is required that the light setting is returned to its original status. For example, in the case wherein the original light setting was ‘off’, the system may reduce its power consumption by turning the lighting device off when the light setting of the subsequent lighting device is changed.

In an embodiment of the system, the processor is further arranged for selecting the first lighting device and/or the subsequent lighting device to be changed based on at least one of the group comprising: a light setting of at least one lighting device of the plurality of lighting devices, a spatial characteristic of at least one lighting device of the plurality of lighting devices, a type of lighting device of at least one lighting device of the plurality of lighting devices and the request signal. This embodiment is advantageous because it allows the system to determine of which lighting device to change the light setting next. This may for example be based on the most probable location of a person in the second space, or the system may for example decide to change only the light setting of lighting devices arranged for creating mood lighting (and for example no lighting devices arranged for providing task lighting). This embodiment also allows the user who provides the request signal to inform the system of a preferred change sequence.

In an embodiment of the system, the processor is arranged for determining the predetermined period of time based on the request signal. This embodiment is advantageous because it may allow the user to determine at which rate the light settings of the plurality of lighting devices are changed. It may also be advantageous if the predetermined period of time is dependent on the type of request signal. For example, the request signal may be sent during an emergency, wherein it may be required that the predetermined period of time is short because urgence may be required, while when a request signal is sent as a social request a longer response time may suffice.

In an embodiment of the system, the processor is located at the first space, and the processor is arranged for communicating with the plurality of lighting devices and the second device via a communication network and/or an intermediate communication device. The processor may be a standalone device, be integrated in the first user input device or in a further device (e.g. a hub, a bridge, etc.) located at the first location. The processor may also be located in an intermediate communication device, which may be advantageous in that it may provide an interface platform between the first user input device, the plurality of lighting devices and the second device. Furthermore, the device comprising the processor may be connected to the internet, allowing sending signals to the plurality of lighting devices.

In an alternative embodiment, the processor is located at the second space, and the processor is arranged for communicating with the first user input device via a communication network and/or an intermediate communication device. The processor may be comprised in a standalone device, in the second device or in a further device located at the second space. In this embodiment, the processor may receive the request signal from the first user input device (e.g. via an internet connection) and control the plurality of lighting devices, thereby functioning as a bridge between the first user input device, the second user input device and the plurality of lighting devices.

According to a second aspect of the present invention the object is achieved by a controller for determining the presence of a person by controlling a plurality of lighting devices, the plurality of lighting devices arranged for providing general illumination, the controller comprising a processor according to the processor of the system as described in any one of the above-mentioned embodiments. The controller may function as an intermediate communication device between the first user input device, the second device and the plurality of lighting devices. The controller may be located at the first space or at the second space. Furthermore, the controller may be comprised in a further device located remotely from both the first and the second space, for example at a remote server, thereby possibly exploiting control and processing capabilities of the remote server.

According to a third aspect of the present invention the object is achieved by a method of determining the presence of a person. The method comprises:

receiving a request signal based on a first user input,

receiving a response signal based on an indication of the presence of the person,

changing a light setting of a first lighting device of a plurality of lighting devices arranged for providing general illumination, located at a second space different from the first space, upon receiving the request signal, and

changing, when a response signal has not been received within a predetermined period of time, the light setting of a subsequent lighting device of the plurality of lighting devices.

In embodiments of the method, an additional step may be included to generate a response status based on the received response signal and/or based on that no response signal has been received within the predetermined period of time and communicate the generated response status to the first user input device.

In embodiments of the method, the response signal is based on at least one of the group comprising: a user input received on the second device, a detection of the person detected by the second device and a detection of a further device by the second device. The second device (e.g. one of the plurality of lighting devices, a smart phone, etc.) may comprise a means for receiving a user input (e.g. via touch, speech, a gesture, etc.), thereby allowing the system to determine the presence (and optionally the identity) of the second person located nearby the lighting device at the second space of which the light output has been changed. Additionally or alternatively, the second device may comprise a means for detecting the presence of the second person (e.g. a camera), thereby allowing the system to determine the presence of the second person. Additionally or alternatively, the second device (e.g. a network hub) may comprise a means for detecting the presence of a further device (e.g. a smartphone), thereby allowing the system to determine the presence (and optionally the identity) of the second person.

According to a fourth aspect of the present invention the object is achieved by a computer program product for a computing device, the computer program product comprising computer program code to perform the method according to the invention when the computer program product is run on a processing unit of the computing device.

### BRIEF DESCRIPTION OF THE DRAWINGS

The above, as well as additional objects, features and advantages of the disclosed system, controller and methods, will be better understood through the following illustrative and non-limiting detailed description of embodiments of devices and methods, with reference to the appended drawings, in which:

FIG. 1 shows schematically an embodiment of a system according to the invention for determining the presence of a person a person in a second space;

FIG. 2 shows schematically three embodiments of the second device located at the second space, arranged for generating a response signal;

FIG. 3 shows schematically an embodiment of a system according to the invention for determining the presence of a person in a second house based on a request signal sent from a first house; and

FIG. 4 shows schematically and exemplary a method of determining the presence of a person a person in a second space.

All the figures are schematic, not necessarily to scale, and generally only show parts which are necessary in order to elucidate the invention, wherein other parts may be omitted or merely suggested.

### DETAILED DESCRIPTION OF EMBODIMENTS

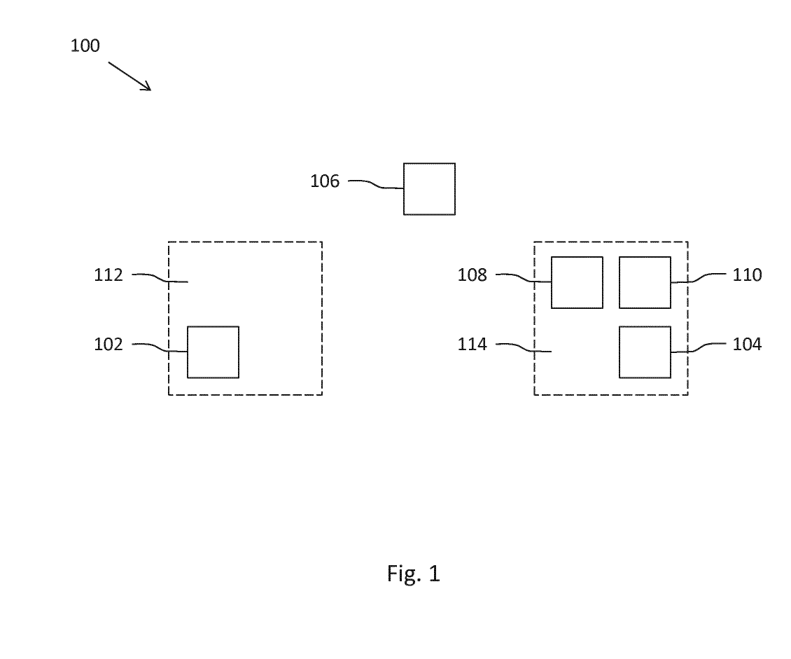

FIG. 1 shows schematically an embodiment of a system 100 according to the invention for determining the presence of a person in a second space 114. The system 100 comprises a first user input device 102 arranged for generating a request signal based on a first user input. The first user input device 102 is located in a first space 112. The system 100 further comprises a plurality of lighting devices 108, 110 arranged for providing general illumination and a second device 104 arranged for generating a response signal, the response signal being based on an indication of the presence of the person. The plurality of lighting devices 108, 110 and the second device 104 are located in the second space 114 different from the first space 112. The system 100 further comprises a processor 106 arranged for receiving the request signal and the response signal. The processor 106 is further arranged for changing a light setting of a first lighting device 108 of the plurality of lighting devices 108, 110 upon receiving the request signal, and for changing, when the response signal has not been received within a predetermined period of time, the light setting of a subsequent lighting device 110 of the plurality of lighting devices 108, 110. The processor 106, the first user input device 102, the second device 104 and the plurality of lighting devices 108, 110 may be interconnected by any kind of communication technology. Various wired and wireless communication technologies that are known in the art may be used, for example Ethernet, Bluetooth, Wi-Fi or ZigBee. A specific communication technology may be selected based on the communication capabilities of the processor 106, the type of lighting devices, the type of second device 104 and the type of first user input device 102, the power consumption of the communication driver for the (wireless) communication technology and/or the communication range of the signals.

This system 100 allows a person located at the first space 112, henceforth referred to as the first person, to request the whereabouts of a person in the second space 114, henceforth referred to as the second person. By changing the light setting of the plurality of lighting devices 108, 110 subsequently, the system 100 provides a presence request at each subspace (a subspace being a space within the second space 114 comprising at least one of the plurality of lighting devices 108, 110). This allows the second person, who is present in a subspace wherein the light setting is changed, to provide the response signal via the second device 104, whereafter the system 100 may communicate the presence (and optionally the location and the identity) of the second person to the first person.

The processor 106 is arranged for changing the light setting of the plurality of lighting devices 108, 110. The change of the light setting may comprise changing an original light setting (i.e. the light setting of the lighting device before being changed by the processor 106) to a ‘request’ light setting. The request light setting may be for example a predetermined system setting, a user defined setting or the request light setting may be determined by the type of request signal. The request light setting may be for example a change of the color and/or brightness of the light source of the lighting device. Additionally or alternatively, the request light setting may be a dynamic light setting wherein the light output of the lighting device changes over time (e.g. flashing, gradually changing color, etc.). In an embodiment, the processor 106 is further arranged for changing the light setting of a preceding lighting device back to its original light setting upon changing the light setting of the subsequent lighting device 110. In this embodiment only one of the plurality of lighting devices 108, 110 is set to the request light setting at the same time and all other lighting devices are set to their original setting (for example to ‘off’, to regular task lighting, to ambient lighting, etc.). The processor 106 may be arranged for changing the light setting of the subsequent lighting devices 110 of the plurality of lighting devices 108, 110 at least until the light setting of each of the plurality of lighting devices 108, 110 has been changed. Alternatively, the system 100 may continue changing the light setting of the plurality of lighting devices 108, 110 after the light setting of each of the plurality of lighting devices 108, 110 has been changed, for example by starting over changing the light settings as if none of the light settings have been changed.

In an embodiment, the processor 106 is arranged for, when no response signal has been received from the second space 114 within the predetermined period of time, subsequently changing the light setting of at least one lighting device in a further space. This allows the system 100 to request the presence of a person in a plurality of spaces, which may be advantageous, for example, when a patient (located in the first space 112) requests the presence of a first doctor in the second space 114. If the first doctor appears to be absent, the system 100 may provide a request for a second doctor in the further space, similar to the change of the light setting of the plurality of lighting devices 108, 110 in the second space 114.

The first user input device 102 allows the first person to provide a user input to send a request signal to the second space 114. The first user input device 102 may for example be a smart device (e.g. a smartphone, a laptop, a tablet pc, a smart watch, etc.) or any other device arranged for communicating the request signal to the processor 106. The request signal may be communicated via for example a wireless connection. The first user input may be received via a first user interface of the first user input device 102. The first user interface may for example comprise a touch-sensitive surface such as a touchpad or a touchscreen, an audio sensor such as a microphone for detecting voice commands, a motion sensor such as an accelerometer and/or a gyroscope for detecting gestures and/or motions and/or one or more buttons for receiving the first user input. The location/use of the first user input device 102 may depend on the embodiment wherein the first user input device 102 is used. In a first example, the first user input device 102 may be for example located in a first house, while the plurality of lighting devices 108, 110 and the one or more second devices 104 are located in a second house. In a second example, the first user input device 102 may be for example located at an office reception, while the plurality of lighting devices 108, 110 and the one or more second devices 104 may be located in a plurality of offices in the same building. In a third example, the first user input device 102 may for example be located near or on the body of the first person (e.g. a smart watch, smart goggles, a smart phone, a tablet pc, etc.), while the plurality of lighting devices 108, 110 and the one or more second devices 104 are located at a remote location, providing a mobile solution for the first person to request the presence of the second person. It should be noted that the above-mentioned examples illustrate rather than limit the invention, and that those skilled in the art will be able to design many alternative examples without departing from the scope of the appended claims.

The lighting devices, located in the second space 114, may be any type of lighting devices arranged for providing general illumination. The lighting devices are further arranged for receiving control commands from the processor 106. The lighting devices may for example be LED lamps, LED strips, Philips Hue lamps, etc. The lighting devices may be arranged for providing task, ambient, atmosphere or accent lighting and may be already installed luminaires or luminaires for a system 100 according to the invention. The plurality of lighting devices 108, 110 may be located in a plurality of subspaces (e.g. rooms, separate spaces in one room, etc.) of the second space 114, and each subspace may comprise a second device 104, thereby enabling the system 100 to receive a response signal at each subspace of the second space 114.

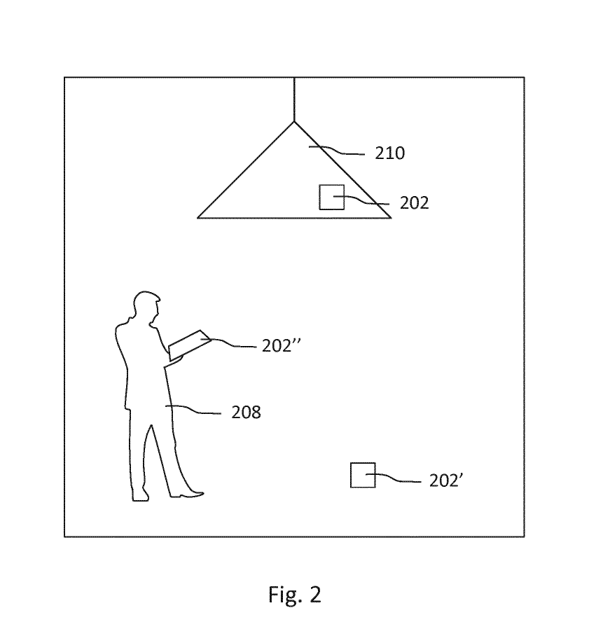

FIG. 2 shows schematically three embodiments of the second device 202, 202′, 202″ located at the second space, arranged for generating a response signal based on an indication of the presence of the second person 208. The second device 202, 202′, 202″ may be any type of device arranged for receiving an indication of the presence of a person.

In a first embodiment, the second device 202 may be comprised in a lighting device 210. This may require that the second space comprises a plurality of second devices 202 for generating the response signal (for example at each lighting device 210 a corresponding second device 202, or in each room a corresponding second device 202).

In a second embodiment, the second device 202′ may be a standalone device or be comprised in a further device (for example in a home automation system). This embodiment may require that the second space comprises a plurality of second devices 202′ for generating the response signal (for example at each lighting device 210 a corresponding second device 202′, or in each room a corresponding second device 202′).

In the above-mentioned first and second embodiments, the second device 202, 202′ may comprise a second user interface for receiving a second user input (not shown), thereby enabling receiving the indication of the presence of the second person 208. The second user interface may for example comprise a touch-sensitive device such as a touchpad or a touchscreen, an audio sensor such as a microphone for detecting voice commands, a motion sensor such as an accelerometer and/or a gyroscope for detecting gestures and/or motions and/or one or more buttons for receiving the second user input. Additionally or alternatively, the second device 202, 202′ may comprise a detector (not shown) arranged for detecting the presence of the second person 208. The detector may comprise for example a camera, a PIR sensor or any other type of presence sensor. This detector may remove the requirement of receiving an active input from the second person 208, enabling the system to communicate the presence of the second person 208 automatically to the processor (not shown in FIG. 2). In an additional or alternative embodiment, the second device 202, 202′ comprises a detector arranged for detecting the presence of, for example, a portable device (e.g. a smartphone). The second device 202, 202′ may for example comprise a radio frequency (RF) transceiver arranged for communicating with the portable device to determine the presence of the portable device. Presence information can be acquired through for example measuring the received signal strength (RSS), wherein the presence is determined based on an RF signal backscattering from a receiving tag comprised in the portable device, or through time-of-flight (TOF) measurement of the RF signal. Furthermore, the second device 202, 202′ may be further arranged for determining the distance of the portable device based on the RSS and/or TOF measurements. It should be noted that the RSS and TOF are examples, and that those skilled in the art will be able to design many alternative presence/distance detection means without departing from the scope of the invention. Additionally, the second device 202, 202′ may be arranged for receiving an identifier from the portable device, thereby enabling the system to determine whose presence is detected by the second device 202, 202′.

In a third embodiment, the second device 202″ may be a device close to the second person 208 in the second space (e.g. a portable device, a smart watch, a smart ring or smart glasses). The second device 202″ may be arranged for detecting the change of the light setting of the lighting device 210 (e.g. by a light sensor, a camera, etc.) and be further arranged for generating, upon detecting the change of the light setting, the response signal. The light emitted by the lighting device 210 may comprise an identifier (e.g. via coded light), thereby allowing the second device 202″ to identify the lighting device 210 and, optionally, determine in which subspace of the second space the second device 202″ is located. If the identifier comprises information about the subspace (e.g. the room) of the lighting device 210, the system may function as a localization tool of persons carrying the second device 202″ close to their person. The second device 202″ may be further configured to differentiate between a regular light setting and a request light setting (e.g. based on color, dynamic behavior of the light, light modulation, coded light, etc.). This embodiment may remove the requirement for an active input from the second person 202″ in the second space to acknowledge presence, which may be advantageous, for example in situations wherein the second person is not capable of providing an input.

In an embodiment, the processor 106 is further arranged for selecting the first lighting device 108 and/or the subsequent lighting device 110 of which the light setting is to be changed based on the original light setting of at least one lighting device of the plurality of lighting devices 108, 110, the original light setting being the light setting before the change by the processor 106. The processor 106 may for example determine to select a specific lighting device because the original light setting of that specific lighting device is ‘on’. The chance that the second person is present nearby a lighting device that is turned on may be higher than the chance that the second person is present nearby a lighting device that is turned off. The processor 106 may comprise further information, like the time of the day and the weather conditions, which may further influence this decision.

In an embodiment, the processor 106 is further arranged for selecting the first lighting device 108 and/or the subsequent lighting device 110 to be changed based on a spatial characteristic of at least one lighting device of the plurality of lighting devices 108, 110. The processor 106 may for example determine to select a specific lighting device based on the location of that lighting device. For example, the light setting of a lighting device in the living room may be more favorable to be changed than the light setting of a lighting device in the attic. The location of the lighting device inside the subspace (e.g. room) of the second space 114 may further determine the decision. The light setting of a lighting device located in the center of a room may be more favorable to be changed compared to a lighting device located in a corner of a room.

In an embodiment, the processor 106 is further arranged for selecting the first lighting device 108 and/or the subsequent lighting device 110 of which the light setting is to be changed based on a type of lighting device of at least one lighting device of the plurality of lighting devices 108, 110. An aspect that may influence the decision to change a light setting of a specific lighting device is the function of the lighting device. The system 100 may for example determine to first change the light setting of lighting devices arranged for providing task lighting, and to change the light setting of lighting devices arranged for providing ambient lighting afterwards. Further aspects such as the luminous intensity, the color options, the device's luminaire, etc. may further influence the decision of which lighting device to change the light setting next.

In an embodiment, the processor 106 is further arranged for selecting the first lighting device 108 and/or the subsequent lighting device 110 of which the light setting is to be changed based on data received from a further device. The further device may be, for example, a building management system 100. The building management system 100 may be arranged to detect behavioral patterns of persons in the second space 114, thereby allowing the processor 106 to determine which lighting device to select based on the behavioral patterns. The further device may also comprise information about the plurality of lighting devices 108, 110, which may be communicated to the processor 106, thereby informing the processor 106 about, for example, the light emission properties of the lighting devices, (mal)functioning lighting devices, connectivity of lighting devices, etc.

In an embodiment, the processor 106 is further arranged for selecting the first lighting device 108 and/or the subsequent lighting device 110 of which the light setting is to be changed based on the request signal. The request signal may comprise information about of which lighting devices to change the light setting, based on, for example, the type of request signal (e.g. an emergency request signal, a social request signal, etc.). Additionally or alternatively, the first person operating the first user input device 102 may provide information to the processor 106 about of which lighting devices to change the light setting in which sequence. Additionally, the first user input device 102 may comprise information about the light settings, location, type, etc. of the lighting devices in the second space 114, and the first user interface of the first user input device 102 may communicate this information to the first person. This may further enable the first person to determine the sequence wherein the light settings of the lighting devices 108, 110 are changed, which may be communicated by the first user input device 102 via the request signal to the processor 106.

In an embodiment, the processor 106 is further arranged for generating a response status based on the response signal or based on that no response signal has been received within the predetermined period of time. The response signal may be communicated to the first user input device 102, thereby informing the first user input device 102 (and, optionally, therewith the user) if and when the response signal has been received. The processor 106 may further communicate by which second device 104 the response signal has been generated. The processor 106 may further change a control parameter of the first user input device 102 based on the response signal. In an embodiment, the first user input device 102 may be, for example, a lighting device comprising the first user interface and a light source. In this embodiment, the processor 106 may change a control parameter of the light source, thereby communicating the presence (or absence) of the second person in the second space 114 to the first person.

In a further embodiment, the system 100 may further comprise at least one further device (e.g. a lighting device) located at the first space 112. The at least one further device in the first space 112 may be any type of device arranged for receiving a control command from the processor 106 (e.g. a television, an LED lamp, a Philips Hue lamp, an audio system 100, etc.). The processor 106 may be further arranged for changing a setting of the at least one further device based on the response status. In the embodiment wherein the first space 112 comprises a plurality of further lighting devices, the processor 106 may change the light setting of the plurality of further lighting devices subsequently, similar to the change of the light setting of the plurality of lighting devices 108, 110 in the second space 114.

In an embodiment, the processor 106 is arranged for determining the predetermined period of time based on the request signal. The predetermined period of time may differ depending on the type of presence request. The presence request may for example be an emergency request (e.g. a request signal sent from a patient to a doctor) wherein it may be desired that the predetermined period of time is short, for example only milliseconds, while when the presence request has a social character, for example a request signal sent from a son to his parents, it may be desired that the predetermined time is longer, providing the system 100 sufficient time to receive the response from either one (or both) of the parents.

In an embodiment, the processor 106 is further arranged for determining at which lighting device a responding person is in vicinity based on the relation between the moment of changing the light setting of a lighting device and the moment of receiving the response signal. The system 100 may comprise information of which lighting device the light setting has been changed and it may comprise information about when the second device 104 and/or which second device 104 has generated the response signal. This allows the system 100 to estimate at which lighting device the second person is in vicinity. If the system 100 comprises information about the location of each lighting device, the system 100 is further able to determine the location (the subspace) of the second person in the second space 114. The accuracy of determining at which lighting device the second person is in vicinity may depend on the predetermined period of time in between the changes of a light setting of a lighting device and a subsequent lighting device 110.

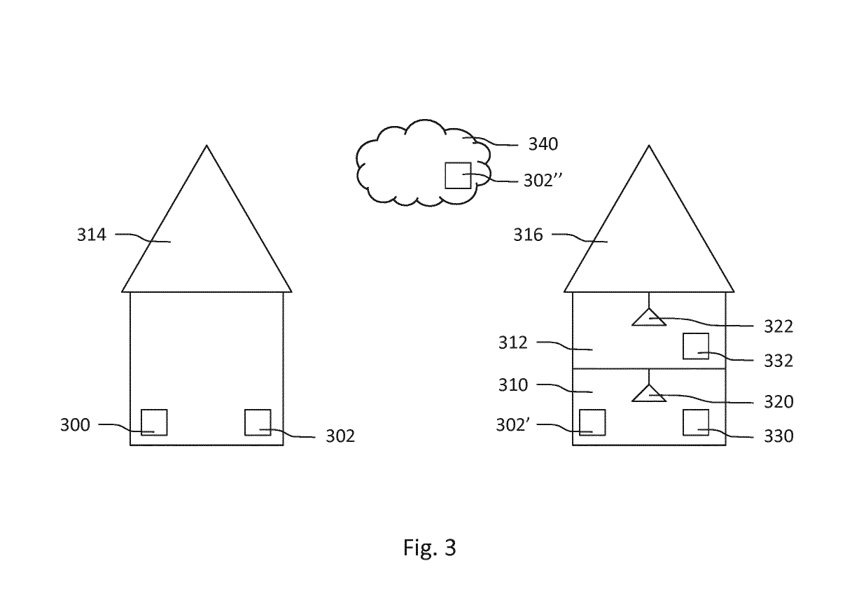

FIG. 3 shows schematically an embodiment of a system according to the invention for determining the presence of a person in a second house 316 based on a request signal sent from a first house 314. The figure shows a plurality of locations where a controller 302, 302′, 302″ may be located. The controller 302, 302′, 302″ comprises a processor (not shown) according to the processor of any one of the above-mentioned embodiments.

In a first embodiment, the controller 302 is located at the first space 314. The controller 302 may be a standalone device or comprised in for example a bridge, a home automation system, a smart device or any other device. The controller 302 is arranged for communicating with the plurality of lighting devices 320, 322 and the second device 330, 332 via for example Wi-Fi, internet, 3G, 4G, 5G, or any other wired or wireless communication protocol. The controller 302 may be further arranged for communicating with an intermediate communication device (e.g. a hub, a router, a smart device, etc.) located at the second space 316. Many intermediate communication devices (e.g. a bridge) today are already equipped with one or more wireless communication technologies, which may be advantageous because this may reduce the effort to create a communication link between the controller 302′, the first device 300, the second device 330, 332 and/or the plurality of lighting devices 320, 322.

In a second embodiment, the controller 302′ is located at the second space 316. The controller 302′ may be a standalone device or be comprised in for example a bridge located at the second space 316. The controller 302′ may be arranged for communicating with the first user input device 300 via any communication network and/or an intermediate communication device. Many intermediate communication devices (e.g. a bridge) today are already equipped with one or more wireless communication technologies, which may be advantageous because this may reduce the effort to create a communication link between the controller 302′, the first device 300, the second device 330, 332 and/or the plurality of lighting devices 320, 322. In an alternative embodiment, the controller 302′ may be located in the second device 330, 332.

In a third embodiment, the controller 302″ is located in a further device, different from both the first space 314 and the second space 316. The controller 302″ may be, for example, comprised in an online remote server 340 (connected via for example the internet) allowing the controller 302″ to receive the request signal from the first user input device 300 (e.g. a smartphone) to change the light setting of the plurality of lighting devices 320,322 (e.g. via an intermediate communication device located at the second space 316) and to receive the response signal from the second device 330, 332 (for example via the intermediate communication device). The remote controller 302″ may further be arranged for communicating the response status to the first user input device 300, thereby informing the first person operating the first user input device 300 about the presence of the second person. It should be noted that the above-mentioned configurations are examples, and that those skilled in the art will be able to design many alternative configurations of the system without departing from the scope of the invention.

FIG. 3 further shows two subspaces 310, 312 in the second space 316. In this embodiment, each subspace 310, 312 comprises a lighting device 320, 322 and a second device 330, 332. The controller 302, 302′, 302″ may determine to change the light setting of the lighting device 320 located in the first subspace 310 of the second space 316 upon receiving the request signal from the first user input device 300. If no indication of presence of the second person is detected by the second device 330 in the first subspace 310 of the second space 316 within the predetermined period of time, the controller 302, 302′, 302″ changes the light setting of the lighting device 322 located in the second subspace 312 of the second space 316. If the second person is present in the second subspace 312 of the second space 316, the second person may provide for example a user input at the second device 332 (or the second device 332 may detect the presence of the person), whereafter no light setting of a further lighting device in a further subspace or further space is changed. Upon receiving the response signal, the controller 302, 302′, 302″ may communicate the response to the first user input device 300.

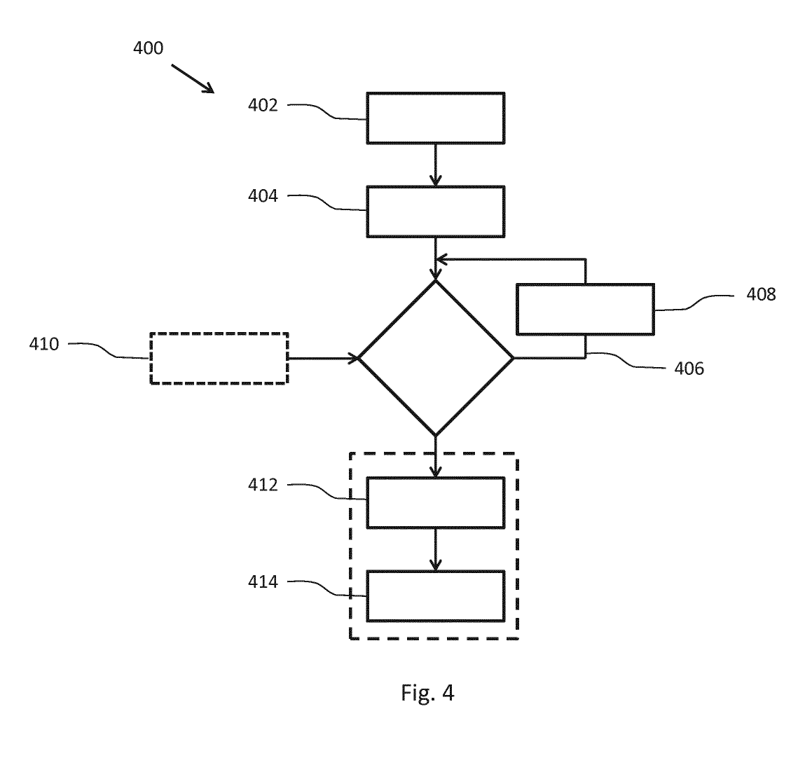

FIG. 4 shows schematically and exemplary a method 400 of determining the presence of a person. The method comprises:

receiving 402 a request signal based on a first user input,

receiving 410 a response signal based on an indication of the presence of the person,

changing 404 a light setting of a first lighting device 108 of a plurality of lighting devices 108, 110 arranged for providing general illumination, located at a second space 114 different from the first space 112, upon receiving the request signal, and

changing 408, when 406 a response signal has not been received within a predetermined period of time, the light setting of a subsequent lighting 110 device of the plurality of lighting devices 108, 110.

As soon as the response signal has been received 410, the system 100 may determine to stop changing the light settings of subsequent lighting devices 110.

In a further embodiment the method 400 of FIG. 4 may further comprise the steps of generating 412 a response status based on the received response signal and/or based on that no response signal has been received within the predetermined period of time and communicating 414 the response status to the first user input device 102. As a result, the first user input device 102 receives the response status, which may further be used to change a control parameter of the first user input device 102, or it may be further used to inform a person operating the first user input device 102 about the response status.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer or processing unit. In the device claim enumerating several means, several of these means may be embodied by one and the same item of hardware. The mere fact that certain measures are recited in mutually different dependent claims does not indicate that a combination of these measures cannot be used to advantage.

1. A system for determining the presence of a person, the system comprising:
a first user input device, located at a first space, arranged for generating a request signal based on a first user input,
a plurality of lighting devices, located at a second space different from the first space, arranged for providing general illumination,
a second device, located at the second space, arranged for generating a response signal, wherein the response signal is based on an indication of the presence of the person, and
a processor arranged for receiving the request signal and the response signal, wherein the processor is further arranged for:
changing a light setting of a first lighting device of the plurality of lighting devices upon receiving the request signal, and
changing, when the response signal has not been received within a predetermined period of time, the light setting of a subsequent lighting device of the plurality of lighting devices
and wherein the processor is further arranged for selecting the first lighting device and the subsequent lighting device of which the light setting is to be changed from the plurality of lighting devices.

2. The system of claim 1, wherein the processor is further arranged for generating a response status based on the response signal or based on that no response signal has been received within the predetermined period of time.

3. The system of claim 2, wherein the processor is further arranged for communicating the response status to the first user input device.

4. The system of claim 1, wherein the second device is arranged for identifying the responding person, and wherein the response signal comprises the identification of the person.

5. The system of claim 1, wherein the processor is further arranged for determining at which lighting device of the plurality of lighting devices the person is in vicinity based on the relation between the moment of changing the light setting of a lighting device and the moment of generation of the response signal.

6. The system of claim 1, wherein the processor is further arranged for changing the light setting of a preceding lighting device to an original light setting upon changing the light setting of the subsequent lighting device, the original light setting being the light setting of the lighting device before being changed by the processor.

7. The system of claim 1, wherein the processor is further arranged for selecting the first lighting device and/or the subsequent lighting device to be changed based on at least one of the group comprising:
a light setting of at least one lighting device of the plurality of lighting devices,
a spatial characteristic of at least one lighting device of the plurality of lighting devices,
a type of lighting device of at least one lighting device of the plurality of lighting devices, and
the request signal.

8. The system of claim 1, wherein the processor is arranged for determining the predetermined period of time based on the request signal.

9. The system of claim 1, wherein the processor is located at the first space, and wherein the processor is arranged for communicating with the plurality of lighting devices and the second device via a communication network and/or an intermediate communication device.

10. The system of claim 1, wherein the processor is located at the second space, and wherein the processor is arranged for communicating with the first user input device via a communication network and/or an intermediate communication device.

11. A controller for determining the presence of a person by controlling a plurality of lighting devices, the plurality of lighting devices arranged for providing general illumination, the controller comprising a processor according to the processor of the system of claim 1.

12. A method for determining the presence of a person, the method comprising:
receiving a request signal based on a first user input,
receiving a response signal based on an indication of the presence of the person,
selecting a first lighting device and a subsequent lighting device of which a light setting is to be changed from a plurality of lighting devices,
changing a light setting of the first lighting device of the plurality of lighting devices arranged for providing general illumination, located at a second space different from the first space, upon receiving the request signal, and
changing, when the response signal has not been received within a predetermined period of time, the light setting of the subsequent lighting device of the plurality of lighting devices.

13. The method of claim 12 further comprising the steps of:
generating a response status based on the received response signal and/or based on that no response signal has been received within the predetermined period of time, and
communicating the response status to the first user input device.

14. The method of claim 12, wherein the response signal is based on at least one of the group comprising:
a user input received on the second device,
a detection of a person detected by the second device, and
a detection of a further device by the second device.

15. A computer program product for a computing device, the computer program product comprising computer program code to perform the method of claim 12 when the computer program product is run on a processing unit of the computing device.
